(19) United States
(12) Patent Application Publication
(10) Pub. No.: US 2006/0154187 A1
(43) Pub. Date: Jul. 13, 2006

(54) Development of radiation-sensitive elements

(76) Inventors: John Wilson, Bozeman, MT (US); John Clayton, Burnaby (CA); Jeffrey A. Cooke, Toronto (CA); Jacqueline Ricafrente, Surrey (CA); Yanguo Yang, Burnaby (CA); Joyce Lukas, Coquitlam (CA)

Correspondence Address: MADSON & AUSTIN;GATEWAY TOWER WEST, SUITE 900, 15 WEST SOUTH TEMPLE, SALT LAKE CITY, UT, 84101, US

(21) Appl. No.: 11/304,075

(22) Filed: Dec. 15, 2005

Related U.S. Application Data
(60) Provisional application No. 60/637,325, filed on Dec. 17, 2004.
(60) Provisional application No. 60/682,392, filed on May 19, 2005.
(60) Provisional application No. 60/693,048, filed on Jun. 23, 2005.

(51) Int. Cl. G03C 5/00

(52) U.S. Cl. 430/331

(57) ABSTRACT

An aqueous alkaline developer for use with an imaged lithographic printing precursor comprises an aqueous alkaline medium, sodium metasilicate, a steric or electrosteric stabilizer, and a rinse aid or a phase stabilizer. It is suited for developing a lithographic printing precursor comprising, on a substrate, a coated and dried layer of a radiation-sensitive composition comprising one or more acetal resins. The developer may further contain a moderator, a dispersing agent capable of solvating a hydrophobic image colorant, and a wetting agent. The acetal resin of the precursor may be derived from polyvinyl alcohol by condensation with aldehydes. The imageable element is imageable by radiation, preferably infrared radiation, and provides good sensitivity for use in lithographic applications, such as conventional imaging systems, computer-to-plate systems or other direct imaging elements and applications when treated with the developer. The invention also provides a positive-working lithographic printing master comprising a precursor as aforesaid, imaged and developed with the developer. The invention further provides a method for cleaning the processor equipment in which the imaged lithographic printing precursor has been developed, comprising treating the deposit with an acid to yield liberated image colorant and treating the liberated image colorant with a cleaning composition.

### CROSS-REFERENCE TO RELATED APPLICATIONS

This application claims the benefit of provisional application No. 60/637,325, filed Dec. 17, 2004, provisional application No. 60/682,392, filed May 19, 2005, and provisional application No. 60/693,048, filed Jun. 23, 2005.

### FIELD OF THE INVENTION

The invention pertains to the field of developers for radiation-sensitive compositions and, in particular, to the removal of development residues from processing equipment used to develop printing plates using radiation-sensitive compositions.

### BACKGROUND OF THE INVENTION

Lithographic processes involve establishing image (printing) and non-image (non-printing) areas on a substrate, substantially on a common plane. When such processes are used in printing industries, non-image areas and image areas are arranged to have different affinities for printing ink. For example, non-image areas may be generally hydrophilic or oleophobic and image areas may be oleophilic.

Radiation-sensitive imaging elements are classified as comprising compositions that undergo transformation(s) in response to exposure to, and absorption of, suitable amounts of radiation. The nature of the induced transformation may be to ablate the composition, or to change the solubility of the composition in a particular developer, or to change tackiness of the surface, or to change the hydrophilicity or the hydrophobicity of the surface of the thermally sensitive layer. As such, selective exposure of predetermined areas of a radiation-sensitive film or layer via imagewise distribution of irradiation has the capability of directly or indirectly producing a suitably imaged film or layer which can serve as a resist pattern in printed circuit board fabrication, or in the production of lithographic printing plates.

Certain types of electronic parts may be manufactured using lithographic manufacturing technology. The types of electronic parts whose manufacture may use a radiation-sensitive composition include printed wiring circuit boards, thick- and thin-film circuits, comprising passive elements such as resistors, capacitors and inductors; multichip devices; integrated circuits; and active semiconductor devices. The electronic parts may suitably comprise conductors, for example copper board; semiconductors and insulators, for example silica, as a surface layer with silicon beneath, with the silica being selectively etched away to expose portions of the silicon beneath. In relation to masks, a required pattern may be formed in the coating on the mask precursor, for example a plastic film, which is then used in a later processing step, in forming a pattern on, for example, a printing or electronic part substrate.

Conventionally, laser direct imaging methods (LDI) have been known which directly form an offset printing plate or printed circuit board on the basis of digital data from a computer. LDI offers the potential benefits of better line quality, just-in-time processing, improved manufacturing yields, elimination of film costs, and other recognized advantages. There has been remarkable development in the area of lasers. In particular, solid state lasers and semiconductor lasers having a luminous band from near infrared wavelengths to infrared wavelengths and which are small-sized and have a high energy output have become commercially available. These lasers are very useful as exposure light sources for exposure when LDI is required.

A large variety of positive-working lithographic printing precursors are known in the art. While these precursors function on a variety of different exposure mechanisms, based on a very wide range of light- or heat-induced chemical processes, a major group of these require alkaline aqueous developers to remove the imageable material in the irradiated area. More specifically, it is quite usual to have a specific developer liquid that is optimized for developing a particular associated imageable element. Examples of developers that may be used for positive-working printing plates are given in U.S. Pat. No. 6,641,980, U.S. Pat. No. 6,649,324, U.S. Pat. No. 6,083,662, U.S. Pat. No. 5,766,826 and U.S. Pat. No. 5,670,294.

The developing solution for a positive-working lithographic printing precursor may typically contain a conventionally known alkali such as, for example, sodium metasilicate, sodium hydroxide, ammonium hydroxide and potassium hydroxide. In some cases, the alkali agent is used alone, whereas in other cases a combination of two or more is used. Among these, particularly popular developing solutions are aqueous solutions of silicates and hydroxides, such as sodium hydroxide and sodium metasilicate.

It is known that when development is carried out by using an automatic developing machine, an aqueous solution (a replenishing solution) having a higher basicity than that of the developing solution is added to the developing solution so that many plates or pieces of can be processed without having to replace the developing solution in the developing tank for a long time.

While a functional developer may be prepared without one of the alkali and the sodium metasilicate, the properties of such a developer will be less than ideal. It is well known that a variety of materials may be added to enhance the performance of the developer. However, there are certain specific combinations that lead to more desirable developers than other combinations.

Surfactants provide a wide range of valuable functional contributions to developer solutions, such as dispersing, stabilizing, wetting properties, rinsability, solubilization and improving the rinsing properties. Various surfactants have been added to developer solutions and to the replenishing solution to accelerate or control developability, improve the dispersibility of development byproducts, control the formation and deposition of sodium aluminosilicates, the major constituent of so-called developer sludge. Surfactants are generally also added to the composition of the developer in order to improve the wetting of the lithographic element being developed. This allows the sodium metasilicate to remove the imaged (irradiated) area of the element more efficiently. Furthermore it helps to lift off the imageable material in those irradiated areas and keeps the material so removed in suspension.

Surfactants are generally comprised of a hydrophobic portion, like a long alkyl chain, attached to hydrophilic or water solubility-enhancing functional groups. Surfactants are typically categorized, according to the charge present in the hydrophilic portion of the molecule (after dissociation in aqueous solution), as anionic surfactants, nonionic surfactants, cationic surfactants, and amphoteric surfactants.

Typically a developer solution will comprise more than one surfactant from more than one surfactant category to achieve the best wetting, dispersing, stabilizing, solubilizing protecting, and rinsing properties.

As the alkali and/or the metasilicate attack the substrate, insoluble alkali aluminosilicate is formed as suspended particles. The size of the particles formed in this process is, at least in part, controlled by the addition of a surfactant which functions as dispersing agent. Various dispersing agents, further solvents, thickeners and other helpful agents have been added to developers to match them to a particular media in addressing the ubiquitous sludge problem.

A further consideration in preparing a suitable developer, is the presence of large quantities of image colorant. The image colorant is typically used as a visible high contrast indicator to discern the imaged from the unimaged areas of an imageable element. This is particularly true in lithographic printing plates. Large amounts of these colorants are set free from the imaged areas of a positive-working lithographic plate during development and, if uncontrolled, may cause extensive staining of equipment, facilities, clothing and even personnel. To the extent that the image colorant is typically incorporated with the developer sludge to form a solid deposit, which adheres to the working surfaces of the processor equipment used for the development process, it can be a major task to clean the processor when such deposits occur. To exacerbate the situation, the intensity of the image colorant is often less in the alkaline environment of the liquid developer. If the developer dries or is neutralized, the intensity of the color increases dramatically. Thus, the extent of contamination of external parts or personnel is often not known immediately. Rather, the extent of contamination is revealed only when the alkaline environment is removed, through neutralization or drying.

If a developer is not matched to the media that it is used to developed, it may attack the radiation-sensitive imageable medium in the unimaged are, thereby affecting both the image and the durability of the medium in that area. For a pressman that translates into reduction in image quality, handling problems and reduced run length.

There is a balance between the aggressiveness of the developer, which controls the throughput of the process, and the sharpness of the printed image determined by the quality and run length of the lithographic printing forme or master created during development. Typically development parameters may be adjusted, for a given lithographic plate and developer set, in order to optimize the result. However, in order to provide the leeway to be able to make such adjustments, the developer has to be formulated so as to have enough adaptability for the particular lithographic plate. For a variety of reasons, there is also variability between plates of a given type. The developer has to be formulated to allow for this over and above the allowance for moving process conditions. If the processing conditions are set for higher throughput, then one of the immediate consequences is an increased rate of generating developer sludge, dye contaminant and polymer redeposition from the removed imageable material.

### SUMMARY OF THE INVENTION

According to the present invention there is provided a aqueous alkaline developer for use with an imaged lithographic printing precursor. The developer is suited for developing a lithographic printing precursor comprising, on a substrate, a coated and dried layer of a radiation-sensitive composition comprising one or more acetal resins. The developer of the present invention comprises within an aqueous medium, (i) sodium metasilicate, (ii) an electrosteric or steric stabilizer which prevents sodium aluminosilicate particles from agglomerating, and (iii) a rinse aid or a phase stabilizer.

The phase stabilizer may be an amphoteric surfactant which acts as a hydrotrope and solubilizing agent for other surfactants in this strongly alkaline developer. The rinse aid may be a non-ionic surfactant to easily rinse away image colorant and polymer from processor surfaces.

The developer may also contain a cationic surfactant which moderates the developer aggressiveness in the non-imaged areas of the imaged lithographic printing precursor.

The developer may further contain one or both of an anionic surfactant as solubilizing agent for the hydrophobic image colorant and the acetal polymer, surfaces, and an anionic surfactant to accelerate the action of removing the imaged areas, an anionic surfactant to prevent corrosion of the substrate.

The acetal resin of the radiation-sensitive layer of the precursor may be derived from polyvinyl alcohol by condensation with aldehydes. The radiation sensitive-composition may further comprise a developability-enhancing compound, and it is capable of being dissolved in an aqueous alkaline solution. The imageable element is imageable by radiation, preferably infrared radiation, and provides good sensitivity for use with a radiation source in lithographic applications, such as conventional imaging systems, computer-to-plate systems or other direct imaging elements and applications when treated with the developer of the present invention.

In a further aspect of the invention, there is provided a positive-working lithographic printing master comprising a precursor as aforesaid, imaged and developed with the developer of the invention, as well as a method for preparing the master.

In a further aspect of the invention, there is provided a method for cleaning the processor equipment in which the imaged lithographic printing precursor has been developed using the aqueous alkaline developer of the invention. This method comprises treating the deposit with an acid to yield liberated image colorant and treating the liberated image colorant with a cleaning composition comprising at least one water-dispersible or water-soluble organic solvent, at least one surfactant and water.

### DETAILED DESCRIPTION OF THE PREFERRED EMBODIMENTS

The invention provides an aqueous alkaline developer for use with an imageable element. The developer preferably comprises within an aqueous medium, sodium metasilicate, an electrosteric stabilizer which prevents sodium aluminosilicate particles from agglomerating (thereby fulfilling the function of a steric stabilizer), and a rinse aid or a phase stabilizer. The developer is described in detail below.

A radiation-sensitive composition for use in a positive-working radiation-sensitive layer of a lithographic precursor, developable by the developer of the invention, comprises, as polymer component (A), one or more polymer compounds capable of being dissolved in an alkali aqueous solution, and a component (B), referred to herein as a “developability-enhancing compound” (B).

The polymer component (A) has some degree of solubility in alkaline aqueous solution, though preferably a low degree. In a radiation-sensitive layer formed from the compositions of the invention, the polymer has low solubility due either to its inherently low solubility, or due to interactions of moieties within its own molecules or interaction with other materials in the composition, for example based on hydrogen bonding or the like. The positive-working radiation-sensitive composition may be coated on a substrate and dried to form a radiation-sensitive imageable layer, thereby creating an imageable element.

For use in the invention, the positive-working radiation-sensitive composition is coated onto a hydrophilic lithographic base and dried, thereby to form a positive-working lithographic printing precursor. When the imageable layer is illuminated, it becomes more soluble in alkaline aqueous solution. By addition of a developability-enhancing compound (B), described in more detail below, the energy needed in exposing the composition to obtain a desired level of developability, using the developer of the present invention, is decreased as compared with a coating that does not contain developability-enhancing compound (B). Areas of the coating that are not exposed to the radiation (and are therefore not heated through the absorption and conversion of the radiation to heat) do not exhibit significant change in the rate of dissolution in developer. While the addition of developability-enhancing compound (B) may in fact to some degree increase the solubility of the coated and dried composition in alkaline aqueous solution, the increase in solubility of the coated and dried composition when illuminated is much enhanced. This provides an improved developability of the image that is formed by the radiation. The solubility in the irradiated areas does not restore to its pre-illumination value after any amount of time subsequent to such illumination.

It is to be understood that an increase in the rate of dissolution of the coating means, for purposes of the invention, an increase that is an amount useful in the image-forming process. It does not include any increase that is less than a useful amount in the image-forming process. The invention provides a positive photosensitive composition for use with a radiation source in lithographic applications, such as conventional imaging systems, computer-to-plate systems or other direct imaging elements and applications. It is stable in its state before exposure and has excellent handling properties.

U.S. Pat. No. 6,255,033 to Levanon et al. describes a polyvinyl acetal polymer having phenolic groups, and also describes its synthesis by the grafting or condensation of aldehydes onto polyvinyl alcohol by acetalization. This polyvinyl acetal polymer can be used in the present invention, either alone, or in combination with other resins, as polymer component (A) of the present invention. The full specification of U.S. Pat. No. 6,255,033 is incorporated by reference herein. The general structure of the polymer is given by the formula:

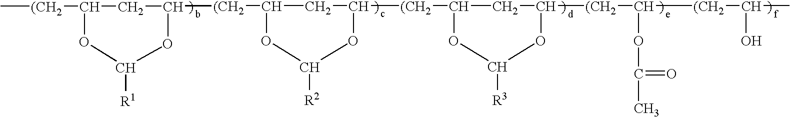

in which R¹ is —CₙH₂ₙ₊₁ where n=1 to 12, and R² is

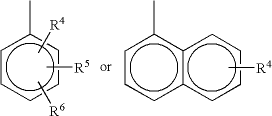

wherein R⁴=—OH;
R⁵=—OH or —OCH₃ or Br— or —O—CH₂—C≡CH and
R⁶=Br— or NO₂

R³=—(CH₂)ₜ—COOH, —C≡CH, or

where

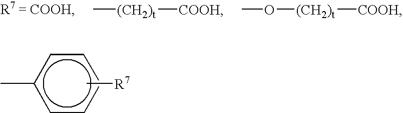

and in which t=1 to 4, and where

b=5 to 40 mole %, preferably 15 to 35 mole %

c=10 to 60 mole %, preferably 20 to 40 mole %

d=0 to 20 mole %, preferably 0 to 10 mole %

e=2 to 20 mole %, preferably 1 to 10 mole % and

f=5 to 50 mole %, preferably 15 to 40 mole %.

The polyvinyl acetal polymers of U.S. Pat. No. 6,255,033 used in the present invention can be described as:
(i) tetrafunctional polymers, in which the recurring unit comprises a vinyl acetate moiety and a vinyl alcohol moiety and first and second cyclic acetal groups, or
(ii) pentafunctional polymers in which the recurring unit comprises a vinyl acetate moiety, a vinyl alcohol moeity and first, second and third cyclic acetal group. All three of the acetal groups are six-member cyclic acetal groups. One of them is substituted with an alkyl group, another is subsituted with an aromatic group having a hydroxyl-, or a hydroxyl- and alkoxyl-, or hydroxyl-, and nitro- and bromine- groups; and a third is substituted with a carboxylic acid group, a carboxylic acid substituted alkyl group or a carboxylic acid substituted aryl group.

Examples of suitable aldehydes useful in preparing the first cyclic acetal group of the polyvinyl acetal polymers used in this invention include: acetaldehyde, propionaldehyde, n-butyraldehyde, n-valeraldehyde, n-caproaldehyde, n-heptaldehyde, isobutyraldehyde and isovaleraldehyde, their mixtures and the like.

Examples of suitable aldehydes useful in preparing the second cyclic acetal group of the polyvinyl acetal polymers used in this invention include 2-hydroxybenzaldehyde, 3-hydroxybenzaldehyde, 4-hydroxybenzaldehyde, 2-hydroxy-1-naphthaldehyde, 2,4-dihydroxybenzaldehyde, 3,5-dibromo-4-hydroxybezaldehyde, 4-oxypropynyl-3-hydroxybenzaldehyde, vanillin, isovanilin and cinnamaldehyde, their mixtures, and the like.

Examples of suitable aldehydes useful in preparing the third cyclic acetal group of the polyvinyl acetal polymers used in this invention include glyoxylic acid, 2-formylphenoxyacetic acid, 3-methoxy-4-formylphenoxy acetic acid and propargyl aldehyde, their mixtures and the like.

This polymer has the advantage that many different functional groups can be incorporated into it to tailor its properties to the specific applications. The long chain alkyl aldehydes may be employed to reduce the softening point (T_{g}) of the polymer for ease of lamination for a dry film photoresist. Aromatic aldehydes, such as cinnamaldehyde, may be employed to increase the oleophilicity of the composition for use in a printing plate. The polymer compounds used as polymer component (A) in this specification preferably have a weight-average molecular weight of 2,000 to 300,000, and a polydispersity index (weight-average molecular weight/number-average molecular weight) of from 1.1 to 10.

A single polymer may be employed alone as polymer component (A), or two or more types of polymers may be used in combination. The amount thereof is from 30 to 95 weight %, preferably from 40 to 95 weight %, and especially preferably from 50 to 90 weight % of the entire content of solids in the composition. If the added amount of the polymer component (A) is less than 30 weight %, the durability of imageable layer made form the composition deteriorates. If the added amount is more than 95% by weight, the sensitivity to radiation deteriorates.

The developability-enhancing compound, used as component (B), may be any one or more of the following class of compounds:
1. Hydroxyl and thiol-containing compounds such as alcohols, phenols, naphthols, thiols and thiophenols.
2. An anionic lithium salt that is one of a carboxylate, thiocarboxylate, sulfate, sulfonate, phosphate, phosphite, nitrate and nitrite;
3. Esters and amides of phosphorous-containing acids, preferably having free hydroxyl groups.
4. Polysiloxane with free hydroxyl groups.
5. Quaternary ammonium salts of phosphorous-containing acids, preferably having free hydroxyl groups.
6. Compounds containing the azo functional group —N═N—
7. Linear and cyclic compounds containing the following groups:
   —NH—NH— and —NH—N═C
8. Sulfones such as dimethylsulfone.
9. Substituted aromatic amides, acids and esters of them.
10. Compounds with the following structures: 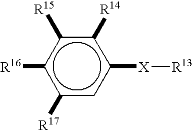
Where X is one of —S—, S═O, C═O, C—O(NH) or C═O(O) and where R¹³ can be H or C₁ to C₁₂-alkyl, benzyl or structure E, where E is given by 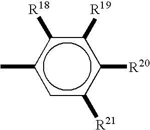
and where R¹⁴, R¹⁵, R¹⁶, R¹⁷, R¹⁸, R¹⁹, R²⁰, R²¹ can be one of Br, Cl, F, NO₂, H or OH.

To provide light-absorption of the laser energy in the radiation-sensitive composition, a radiation-to-heat converting compound (C), capable of absorbing incident radiation, preferably infrared radiation, and converting it to heat, is preferably incorporated in the coating composition. The radiation-to-heat converting compounds suitable for the invented heat-sensitive compositions may be chosen from a wide range of organic and inorganic pigments such as carbon blacks, phthalocyanines or metal oxides. Green pigments: Heliogen Green D8730, D 9360, and Fanal Green D 8330 produced by BASF; Predisol 64H-CAB678 produced by Sun Chemicals, and black pigments: Predisol CAB2604, Predisol N1203, Predisol Black CB-C9558 produced by Sun Chemicals Corp., are examples of effective heat absorbing pigments, and other classes of materials absorbing in the near infrared region are known to those skilled in the art. Preferable infrared absorbing materials for use as radiation-to-heat converting compound are those absorbing at wavelengths longer that 700 nm, such as between about 700 and 1300, with near infrared absorbing materials (between about 700 and 1000 nm) being generally used.

For infrared laser sensitive compositions, the dyes that can be used may be any known infrared dyes. Specific examples of dyes which absorb infrared or near infrared rays are, for example, cyanine dyes disclosed in Japanese Patent Application Laid-Open (JP-A) Nos. 58-125246, 59-84356, 59-202829, and 60-78787; methine dyes disclosed in JP-A Nos. 58-173696, 58-181690, and 58-194595; naphthoquinone dyes disclosed in JP-A Nos. 58-112793, 58-224793, 59-48187, 59-73996, 60-52940 and 60-63744; squarylium colorant disclosed in JP-A No. 58-112792; substituted arylbenzo(thio)pyrylium salts described in U.S. Pat. No. 3,881,924; trimethinethia pyrylium salts described in JP-A No. 57-142645 (U.S. Pat. No. 4,327,169); pyrylium-based compounds described in JP-A Nos. 58-181051, 58-220143, 59-41363, 59-84248, 59-84249, 59-146063, and 59-146061; cyanine colorant described in JP-A No. 59-216146; pentamethinethiopyrylium salts described in U.S. Pat. No. 4,283,475; and pyrylium compounds, Epolight III-178, Epolight III-130 and Epolight III-125 described in Japanese Patent Application Publication (JP-B) Nos. 5-13514 and 5-19702 and cyanine dyes disclosed in British Patent No. 434,875. Particularly preferred dyes are ADS830A IR dye from American Dye Source, Montreal, QC, Canada, and S0451 and S0094 from FEW Chemicals in Wolfen, Germany.

The pigments or dyes may be added into the radiation-sensitive layer for a printing plate, or to other compositions, such as an etch resist in an amount of from 0.01 to 30 weight %, preferably from 0.1 to 10 weight %, and especially preferably from 0.5 to 10 weight % in the case of the dye and from 3 to 13 weight % in the case of a pigment, with respect to the entire amount of solids in the material for the printing plate. If the pigment or dye content is less than 0.01 weight %, sensitivity is lowered. If this content is more than 30 weight %, uniformity of the photosensitive layer is lost and durability or other properties such as etch resistance of the imageable layer deteriorates.

It is possible to have, in place of a separate polymer (A) and infrared absorbing compound, a polymer in which the infrared absorbing material is bonded to the polymer. Examples of these materials are given in U.S. Pat. No. 6,124,425.

A compound that reduces the solubility of the polymer in the alkaline aqueous solution, herein referred to as a “dissolution inhibitor” may optionally be included in the coating composition. Such compounds include, but are not limited to, dyes such as Victoria Pure Blue BO (Basic Blue 7, CAS# 2390-60-5). The use of such compounds is preferred where the inherent solubility of the polymer is relatively high.

Image colorants may optionally be included in the compositions in order to provide a visual image on the exposed plate prior to inking. As the image colorant, dyes may be used. Examples of preferred dyes include the salt forming organic dyes, oil-soluble dyes and basic dyes. Specific examples are Oil-Yellow #101, Oil Yellow #103, Oil Pink #312, Oil Green BG, Oil Blue BOS, Oil Blue #603, Oil Black BY, Oil Black BS, Oil Black T-505 (all of which are manufactured by Orient Chemical Industries Co,. Ltd.), Victoria Pure Blue BO, the tetrafluoroborate salt of Basic Blue, Victoria Pure Blue B07, Crystal Violet (CI42555), Methyl Violet (CI42535), Ethyl Violet, Rhodamine B (CI145170B), Malachite Green (CI42000), Methylene Blue (CI52015), or the like. The dyes described in JP-A No. 62-293247 are especially preferred. The dye may be added into the material for the printing plate in an amount of preferably from 0.01 to 10 weight % and more preferably from 0.5 to 8 weight % of the entire solid contents of the material for the composition.

The positive radiation-sensitive medium used in the present invention may be prepared without the radiation-to-heat converting compound (C). The radiation-sensitive medium may be incorporated into a positive-working lithographic printing precursor in an imageable layer that is separate from, but adjacent to, the layer comprising the converting compound (C). While it is possible to coat the layer comprising the converting compound (C) on top of the imageable layer comprising the radiation-imageable medium, the preferred arrangement is to have the layer comprising the converting compound (C) sandwiched between the imageable layer and the hydrophilic lithographic base, the imageable layer being transparent to the radiation employed for imaging. When the combined layer structure is illuminated, the layer comprising the converting compound (C) produces heat in the illuminated areas, the heat being then imagewise transferred to the adjacent imageable layer comprising the radiation-sensitive medium. The radiation-sensitive medium then becomes more soluble in alkaline aqueous solution in the imagewise heated areas. The result is a decrease in the energy needed in exposing the composition to obtain a desired level of developability, as compared with a coating that does not contain component (B). The term “hydrophilic lithographic base” is used herein to describe a plate or sheet of material of which at least one surface is hydrophilic, thereby allowing it to hold water or aqueous media, such as fountain solution.

In order to achieve processing stability in a broader range of processing conditions, a surfactant may optionally be included in the compositions of the invention. Suitable nonionic surfactants are described in JP-A Nos. 62-251740 and 3-208514 and amphoteric surfactants described in JP-A Nos. 59-121044 and 4-13149. The amount of the nonionic or amphoteric surfactant is preferably from 0.05 to 10 weight percent and more preferably from 0.1 to 5 by weight % of the material for the composition.

A surfactant for improving the applying property, for example, any of the fluorine-containing surfactants such as, for example, Zonyl's (DuPont) or FC-430 or FC-431 (Minnesota Mining and Manufacturing Co.) or alternatively polysiloxanes such as Byk 333 (Byk Chemie), may be added into the infrared sensitive layer. The amount of the surfactant added is preferably from 0.01 to 1 weight % and more preferably from 0.05 to 0.5 weight % of the entire material for the composition.

A plasticizer for providing the formed film with softness may be added as needed in the material for the compositions of the invention. The plasticizer may be e.g. butylphthalyl, polyethyleneglycol, tributyl citrate, dibutyl phthalate, dioctyl phthalate, tricresyl phosphate, tributyl phosphate, tetrahydrofurfuryl oleate, an oligomer or polymer of acrylic acid or methacrylic acid, or the like, sorbitan tristearate, sorbitan monopalmitate, sorbitan trioleate, monoglyceride stearate, polyoxyethylene-nonylphenylether, alkyldi(aminoethyl)glycine, alkylpolyaminoethylglycine hydrochloride, 2-alkyl-N-carboxyethyl-N-hydroxyethylimidazolium betaine, N-tetradecyl-N,N-betaine (e.g., trade name Amogen, manufactured by Dai-ichi Kogyo Co., Ltd.), and the like.

Suitable adhesion promoters may optionally be included in the compositions used in the invention. Suitable ones include di-acids, triazoles, thiazoles and alkyne containing materials. The adhesion promoters are used in amounts between 0.01 and 3% by weight. Other polymers may be added to reduce the cost of the formulation. Examples include urethane and ketone resins. The amounts of these materials can vary between 0.5% and 25%, preferably between 2% and 20% by weight of solids.

In general, the composition ratio of the polymer component (A) to the component (B) is preferably from 99/1 to 60/40. The developability-enhancing compound (B) must be present in an amount that is effective to significantly increase the sensitivity of the coating to the developer in the radiation-exposed areas of the coating, that is, increased by an amount useful in the image-forming process. If the amount of component (B) is lower than this lowest limit, the component (B) does not significantly improve the sensitivity of the coating. If the amount of component (B) is more than the aforementioned upper limit, the tolerance to developer of unimaged coating is significantly reduced. Thus, both cases are not preferred. More preferred ranges for component (B) are 1.5% to 20% and most preferred ranges are 5% to 15%, measured by weight relative to the total solids in the coating composition.

The positive-working lithographic printing precursor used in the present invention can be produced by dissolving the aforementioned respective components into an appropriate solvent, filtering if necessary, and applied from a liquid in a manner known, such as, for example, bar coater coating, spin coating, rotating coating, spray coating, curtain coating, dip coating, air knife coating, blade coating, and roll coating, or the like, onto a hydrophilic lithographic base. Appropriate solvents include methylenechloride, ethylenedichloride, cyclohexanone, methylethyl ketone, acetone, methanol, propanol, ethyleneglycolmonomethylether, 1-methoxy-2-propanol, 2-methoxyethyl acetate, 1-methoxy-2-propyl acetate, dimethoxyethane, methyl lactate, ethyl lactate, and toluene or the like. A single solvent may be used alone, or a combination of two or more solvents may be used. The concentration of the aforementioned components (all of the solid components including the additives) in the solvent is preferably from 1 to 50 weight %. The applied amount (of the solid) on the hydrophilic lithographic base obtained after application and drying differs in accordance with the use, but in general, is preferably from 0.3 to 12.0 grams per square meter according to the application. Lesser amounts can be applied to the hydrophilic lithographic base, resulting in a higher apparent sensitivity, but the film characteristics of the material are deteriorated.

The radiation-sensitive compositions used in the present invention are useful for production of printing circuit boards, for lithographic printing plates and other heat-sensitive elements suitable for direct imaging, including but not limited to laser direct imaging (LDI). In the case of lithographic printing, the positive-working lithographic printing precursor of the present invention employs a hydrophilic lithographic base which may, in a general case, comprise a separate hydrophilic layer over a substrate, such that, when the precursor is developed, the hydrophilic coating layer remains, and is employed in the printing process for retaining aqueous media such as fountain solution. In such a case, there is great latitude in choosing a substrate on which to coat the hydrophilic layer. Alternatively, the hydrophilic lithographic base may be of a single material and this material, which may typically be aluminum, may be treated to assure a hydrophilic surface property.

Suitable substrates may include, for example, paper; paper on which plastic such as polyethylene, polypropylene, polystyrene or the like is laminated; a metal plate such as an aluminum, anodized aluminum, zinc or copper plate; a copper foil, reverse treated copper foil, drum side treated copper foil and double treated copper foil clad on a plastic laminate, a plastic film formed of, for example, cellulose diacetate, cellulose triacetate, cellulose propionate, cellulose butyrate, cellulose acetate butyrate, cellulose nitrate, polyethylene terephthalate, polyethylene, polystyrene, polypropylene, polycarbonate, or polyvinyl acetal; a paper or a plastic film on which the aforementioned metal is vapor-deposited or laminated; glass or glass in which a metal or metal oxide is vapor deposited or the like.

As the substrate for a printing plate, a polyester film, or an aluminum plate is preferred, and an aluminum plate is especially preferred because of its stable dimensions and relatively low cost. A plastic film on which aluminum is laminated or vapor-deposited may be used. The composition of the aluminum plate applied to the present invention is not specified, and the aluminum plate may be prepared according to any of the known methods, for example of roughening, anodizing and post anodizing treatments. The thickness of the aluminum plate used in the present embodiment is from about 0.1 to 0.6 mm, preferably from 0.15 to 0.5 mm.

The positive-working lithographic printing precursor produced as described above is usually subjected to image-exposure and developing processes. In a preferred embodiment, radiation-sensitive compositions as described above are applied as a coating on a hydrophilic lithographic base (for example an aluminum plate) to form a lithographic printing precursor. The precursor can be imaged (for example by imagewise exposure to infrared radiation), and the imaged precursor developed to form a positive-working lithographic printing plate, using an alkaline aqueous developer solution, and may be finally post-processed.

In a preferred embodiment of the present invention, the imaged precursor is developed in a processor with the developer of the present invention. When the precursor has a separate imageable layer and layer comprising the converter substance, the development process removes both layers, to reveal the underlying hydrophilic surface.

In this specification the term “processor” is used to describe automated equipment for developing the imaged lithographic printing precursor. Such equipment typically comprises a reservoir for holding developer, brushes for brushing the imaged precursor with developer, a means for recirculating the developer, a means for controlling the temperature of the developer and a means for rinsing the imaged and developed precursor. The imaged precursor is typically transported through the processor by means of rollers. During the development process a deposit may be formed in the processor, the deposit comprising a solid mix of sludge and image colorant. Such deposits may interfere with recirculation and temperature control within the processor and may, in some cases, locate on the imaged and developed precursor, leading to unwanted artifacts in the ultimately printed image. These deposits can be extremely difficult to remove. Conventional processor cleaners often require brushing, scrubbing or dismantling of the processor. After extensive experimentation, the inventors have found a method for cleaning the processor that is surprisingly and unexpectedly advantageous. In particular, this invention allows for the rapid and safe eluation of processor deposits without requiring the extensive mechanical action typifying many current commercial products. The invention is particularly useful in situations where the lithographic printing plate precursors contain high levels of image colorant, such as those colorants that are also used as solubility suppressants.

In a preferred embodiment of the invention, the light source for an active light beam which is used in the image-exposure, is preferably a light source emitting light having a luminous wavelength within the range from the near infrared wavelength region to the infrared wavelength region, and is especially preferably a solid state laser or a semiconductor laser. Preferably, the positive-working lithographic printing precursor based on the radiation-sensitive medium of the present invention is sensitive to radiation of wavelength between 700 nm and 1300 nm, and more preferably between 700 nm and 1000 nm.

The radiation-sensitive composition used in the invention is usually post-processed with water, optionally containing, for example, a surfactant. In the case of printing plates a desensitizing solution containing gum arabic or a starch derivative is used. Various combinations of these treatments can be used as the post-processing carried out when the imageable medium is used in its different applications.

The processor is cleaned as follows. All developer is drained from the processor and the inside of the processor, including its brushes, is thoroughly rinsed with water and drained. The processor is filled with an acid solution that comprises a mixture of acid and surfactant and the mixture may be allowed to circulate for 30 to 60 minutes. Optionally, the mixture is heated using the temperature control of the processor. To remove the deposit from the rollers, the rollers are brushed with the mixture. The acid is preferably an inorganic acid. Among the inorganic acids, preferred acids are chosen from among nitric acid, sulfuric acid, phosphoric acid and hydrochloric acid. Mixes of these acids may be employed. A particularly preferred acid is nitric acid in water at a concentration of below 15 wt %. The surfactant incorporated in the mix of acid and surfactant of the present invention is chosen to be capable of wetting the deposit and to aid in the penetration of the acid into the matrix of the deposit. Preferred surfactants include, but are not limited to alkylaryl sulfonates, carboxylic acid alkali salts, fatty acid alkali salts, alkyl sulfonates, olefin sulfonates, phosphate esters, alkyl sulfates, alkylaryl sulfates, aryl sulfonates and alkyl phenol alkoxylates. The mix of acid and surfactant may comprise 0.05 wt % to 0.3 wt % of surfactant in water.

The processor is then drained and rinsed with water. The processor is then filled with the cleaning composition of the present invention, which comprises at least one solvent, at least one surfactant and water. The mixture may be allowed to circulate for between 30 and 60 minutes, the temperature being optionally raised by the temperature control of the processor. In this process the acid treatment step dissolves the deposit and is believed to free the image colorant or dye. The treatment with the cleaning composition of the present invention then dissolves the image colorant liberated by the acid treatment, the combined steps providing a method for eluating the deposit.

The Developer

The preferred developer of the invention is a composition that comprises an alkali, various surfactants, and an electrosteric or steric stabilizer. A preferred alkali is sodium metasilicate.

The electrosteric or steric stabilizer incorporated in the developer of the invention inhibits silicate particles in agglomerating and settling out as sludge in the development process. Steric stabilizers which may be used in the invention include natural gums such as xanthan gum, guar gum, or other gum from plant mucilage. Electrosteric stabilizers are preferred. Preferably the electrosteric stabilizer is an aqueous soluble polymer, and more preferably it is an aqueous soluble low molecular weight polymer. Suitable aqueous soluble polymers include, but are not limited to, aqueous soluble polyacrylates, aqueous soluble polysaccharides and aqueous soluble derivatives of polysaccharides. Suitable aqueous soluble polyacrylates include, but are not limited to, sodium polyacrylate. Suitable aqueous soluble derivatives of polysaccharides include, but are not limited to, cellulosic polymers. Suitable cellulosic polymers include, but are not limited to, sodium carboxymethyl cellulose. Preferred sodium carboxymethyl cellulose compounds have molecular weight between 25,000 to 130,000, more preferably between 60,000 and 110,000, and most preferably between 80,000 and 100,000. The degree of substitution is preferably between 0.7 and 0.9.

A first surfactant that may be incorporated in the developer of the invention is chosen to be capable of wetting the hydrophobic image area, and thereby accelerating the removal of the imaged areas. This first surfactant may also be referred to as a “wetting agent”. Preferred examples include, but are not limited to, anionic surfactants of the alkylaryl sulfonates and alkyl sulfonates class. A suitable alkyl sulfonate is sodium octane sulfonate. The first surfactant may also function as an anti-corrosion additive and prevent corrosion of the substrate.

The developer of the invention may comprise a second surfactant, which moderates the developer aggressiveness in removing coating from the non-imaged areas. This second surfactant is also referred to as a “moderator’. Preferably the moderator is a cationic surfactant. Suitable cationic surfactants for use in the present invention include, but are not limited to, quaternary halides of fatty acids. More preferably the cationic surfactant is a fatty acid quaternary ammonium chloride. High ratio sodium silicates may also be used as moderators. Sodium silicates with SiO₂: Na₂O ratio of 2:1 or higher are particularly preferred.

The developer may additionally comprise a third surfactant, which aids in dispersing the developed-off image material like hydrophobic image colorants. This third surfactant may also be referred to as a solubilizing agent, dispersing agent or deflocculating agent. In this specification the term “dispersing agent” shall be used to describe this surfactant.

Typical hydrophobic image colorants include, but are not limited to, Oil-Yellow #101, Oil Yellow #103, Oil Pink #312, Oil Green BG, Oil Blue BOS, Oil Blue #603, Oil Black BY, Oil Black BS, Oil Black T-505 (all of which are manufactured by Orient Chemical Industries Co,. Ltd.), Victoria Pure Blue BO and the tetrafluoroborate salts of Basic Blue. A most preferred image colorant is Victoria pure Blue BO7 and the dispersing agent may be chosen to solubilize or disperse this image colorant. Preferred dispersing agents include, but are not limited to, anionic surfactants such as naphthalene sulfonates. Preferred naphthalene sulfonates include, but are not limited to, neutralized formaldehyde condensation products of a naphthalene sulfonic acid. Preferred neutralized formaldehyde condensation products of a naphthalene sulfonic acid include, but are not limited to, naphthalene sulfonic acid sodium salts of formaldehyde condensates and alkyl naphthalene sulfonic acid sodium salts of formaldehyde condensates.

The developer may further comprise a fourth surfactant, which is a rinse aid. The addition of this fourth surfactant significantly improves the ease with which developed-off image material, consisting of image colorant and acetal polymer, can be rinsed off any processor surfaces. Preferred rinse aids include non-ionic surfactants. Preferred non-ionic surfactants include, but are not limited to, alkyl polyglycosides.

A fifth surfactant may be incorporated in the developer to ensure that the composition remains phase stable and in a single highly active aqueous form. The fifth surfactant may act as a hydrotrope coupler or solubilizing agent for other surfactants in this strongly alkaline developer. In the present specification, the fifth surfactant shall be referred to as a “phase stabilizer”. Representative classes of hydrotrope solubilizers include anionic surfactants such as alkyl sulfates, alkyl or alkyl aryl sulfonates, alkyl naphthalene sulfonate , and amphoteric surfactants. Without being bound to a particular theory, the inventors believe that in the composition of the present invention, the anionic surfactant and in particular the naphthalene sulfonate sodium salt over time forms a solid precipitate with the cationic surfactant, in particular the fatty acid quaternary ammonium chlorides. The precipitate is prevented by the addition of the fifth surfactant. The phase stabilizer preferably is an amphoteric surfactant. Amphoteric surfactants useful with the invention include, but are not limited to, beta-N-alkylaminopropionic acids, n-alkyl-beta-iminodipropionic acids, imidazoline carboxylates, n-alky-lletaines, amine oxides, sulfobetaines and sultaines. Preferably the fifth surfactant of the developer of the invention is octyl dipropionate.

The developer may further comprise other additives, such as defoamers or solvents.

Cleaning Composition

The cleaning composition of the invention comprises at least one organic solvent, at least one surfactant and water. The at least one water-dispersible or water-soluble organic solvent incorporated in the cleaning solution is chosen to be capable of solvating hydrophobic image colorants, more specifically Victoria Pure Blue BO and the tetrafluoroborate salts of Basic Blue. Preferred organic solvents include, but are not limited to, alcohols, ethers and esters. A most preferred organic solvent is an alkylene glycol alkyl ether or a blend of alkylene glycol alkyl ethers. The at least one surfactant incorporated in the cleaning solution of the present invention is chosen to aid in dispersing the image colorant. In the present specification, this surfactant shall be referred to as an “image colorant dispersant” to differentiate it, in the general case, from the surfactant used as dispersing agent in the developer. Preferred image colorant dispersants include, but are not limited to alkylaryl sulfonates, carboxylic acid alkali salts, fatty acid alkali salts, alkyl sulfonates, olefin sulfonates, phosphate esters, alkyl sulfates, alkylaryl sulfates, aryl sulfonates and alkyl phenol alkoxylates. A preferred alkylaryl sulfonate is a naphthalene sulfonate formaldehyde copolymer. In one embodiment of the present invention the image colorant dispersant is the same surfactant as that employed as the “dispersing agent” in the developer.

Preferred compositions of the cleaning composition of the current invention comprise surfactant in the range of 1 wt % to 3 wt % and water-dispersible or water-soluble organic solvent in the range of 25 wt % to 75 wt % in water.

Preparation of the Acetal Polymers Employed in the Radiation-sensitive Coatings.

Acetalization of the polyvinyl alcohols takes place according to known standard methods as described, for example, in U.S. Pat. No. 4,665,124; U.S. Pat. No. 4,940,646; U.S. Pat. No. 5,169,898; U.S. Pat. No. 5,700,619; U.S. Pat. No. 5,792,823; and JP 09,328,519.

(1) Polymer 1

In a preferred embodiment, the polymer employed as polymer component (A) is derived from 3-hydroxybenzaldehyde and butyraldehyde by the following process, resulting in a polyvinyl acetal resin having butyral acetal groups and hydroxy-substituted aromatic acetal groups, herein referred to as Polymer 1, the hydroxy-substitution being on the 3-position on the aromatic ring:

100 grams of Airvol 103 polyvinyl alcohol (a 98% hydrolyzed polyvinyl acetate having a number average molecular weight of about 15,000), was added to a closed reaction vessel fitted with a water-cooled condenser, a dropping funnel and thermometer, and containing 150 grams of demineralized water and 25 grams of methanol. With continual stirring, the mixture was heated for 0.5 hour at 90° C. until it became a clear solution. After this, the temperature was adjusted to 60° C. and 3 grams of concentrated sulfuric acid in 50 grams of methanol were added. Over a 15 minutes period, a solution of 60 grams of 3-hydroxybenzaldehyde and 1.4 grams of 2,6-di-t-butyl-4-methylphenol in 450 grams of Dowanol PM™ were added in a drop-wise manner. The reaction mixture was diluted with additional 200 grams of Dowanol PM™, and 23.2 grams of n-butyraldehyde in 200 grams of Dowanol PM™ were added in a dropwise manner, upon complete addition of the aldehydes, the reaction was continued at 50° C. for additional 3 hours. At this stage the conversion of the butyraldhyde is completed and the conversion of the 3-hydroxybenzaldehyde is close to 50%. The water-Dowanol PM™ azeotrope is distilled out from the reaction mixture in vacuum, Dowanol PM™ is added to the reaction mixture during the distillation. The distillation is complete when the water content of the reaction mixture is lower than 0.1%. The conversion of the 3-hydroxybenzaldehyde is higher than 97%. The reaction mixture is precipitated in water. The resulting polymer is filtered, washed with water and dried at 60° C. for 3 days to a water content of 2%.

(2) Polymer 2

In a preferred embodiment, the polymer employed as polymer component (A) is derived from 3-hydroxybenzaldehyde, butyraldehyde and cinnamaldehyde by, resulting in a polyvinyl acetal resin having butyral acetal groups, cinnamal acetal groups and hydroxy-substituted aromatic acetal groups, herein referred to as Polymer 2, the hydroxy-substitution being in the 3-position on the aromatic ring. The preparation of Polymer 2 is identical to that of Polymer 1, except that addition of the 3-hydroxybenzaldehyde is followed by addition of 14.7 grams of cinnamaldehyde in 150 g of Dowanol PM™ and followed by 16 grams of butyraldehyde in 200 g of Dowanol PM™. The presence of cinnamaldehyde in the composition of Polymer 2 is thought to improve the ink-attracting ability of the imageable areas of the plate.

### EXAMPLES

The following examples illustrate aspects of the invention. Materials were obtained from the following sources:

Tween™ 80K from Avecia of Manchester, UK.

ADS 830A IR dye from American Dye Source, Montreal, QC, Canada.

S0451 and S0094 from FEW Chemicals GmbH in Wolfen, Germany.

Dowanol PM™ from FE Dow Chemical Company, Midland,Mich.

Basic Blue 7.1 (BF₄) from FEW Chemicals GmbH in Wolfen, Germany.

2-(carbamoylazo)isobutyronitrile from Waco Pure Chemical Industries Ltd., Osaka, Japan.

Sodium Metasilicate from The PQ Corporation, Philadelphia, Pa.

BYK-1650 defoamer from BYK-Chemie GmbH, Wesel, Germany

Sodium octanesulfonate, a detergent and anticorrosion additive from Stepan Corporation, Northfield, Ill.

DeTERIC ODP-LF, an amphoteric surfactant from DeForest Enterprises, Inc., Boca Raton, Fla.

Naphthalene sulfonic acid,formaldehyde, sodium salt, copolymer from The Dow Chemical Company, Midland, Mich.

Glucopon 600 UP, an alkyl polyglycoside surfactant from Cognis Corporation, Cincinnati, Ohio.

Fatty acid quaternary ammonium chloride from Chemax Performance Products, Greenville, S.C.

Sodium carboxymethyl cellulose from Sigma-Aldrich, Oakville, ON Canada.

The preferred solids of the radiation-sensitive composition are given in Table 1:

TABLE 1

| Component | Weight % |
|---|---|
| Polymer: weight % Polymer 1: weight % polymer 2 65:35 | 76.75 |
| Developability-enhancing compound: 2-(carbamoylazo) | 10 |
| isobutyronitrile | |
| Radiation-to-heat converting compound(C): S0094 | 0.85 |
| Radiation-to-heat converting compound(C): ADS830A | 0.4 |
| (or S0451) | |
| Image Colorant - Basic Blue 7.1 (BF4) | 7 |
| Surfactant: Tween 80 | 5 |

The components of the radiation-sensitive composition were dissolved in a mixture of 75:25 acetone: Dowanol PM™, filtered and coated on the surface of anodized aluminum. After drying, the resulting plate has a coating weight of 1.5 grams/m² dry thickness. The plate was imaged in the Creo Lotem 400 Quantum at 490 rpm with power densities from 6 to 18 Watts. Plates made by the above procedure were developed in four different developers Examples 14, as listed in Table 2. Example 1 is a reference example. In all cases development was for 30 seconds at 24° C. The results of the developer trials are given in Table 3.

TABLE 2
Developer Compositions

| | Examples - weight % (solids) | | | |
|---|---|---|---|---|
| | 1 | 2 | 3 | 4 |
| Sodium Metasilicate | 7.0000 | 7.0000 | 9.0000 | 8.5000 |
| Sodium Octanesulfonate (40%) | 0.0000 | 0.3500 | 0.3500 | 0.0850 |
| (Bioterge PAS-8) | | | | |
| Octyl Dipropionate (50%), | 0.0000 | 0.0000 | 0.0000 | 0.8500 |
| (DeTERIC ODP-LF) | | | | |
| Naphthalene sulfonate, | 0.0000 | 0.1000 | 0.1000 | 0.5000 |
| sodium salt, | | | | |
| formaldehyde, copolymer, | | | | |
| (Daxad 16L) | | | | |
| Alkyl Polyglycoside, (50%) | 0.0000 | 0.0000 | 0.0000 | 0.3500 |
| (Glucopon 600 UP) | | | | |
| Organic fatty acid | 0.0000 | 0.0125 | 0.0250 | 0.06375 |
| quaternary chloride (40%) | | | | |
| (Hydromax 300) | | | | |
| Sodium carboxymethyl cellulose | 0.0000 | 0.0100 | 0.0100 | 0.0085 |
| (d.s. 0.70) (Low Viscosity: 50 - | | | | |
| 200 CPS (C = 4%, | | | | |
| H2O @ 25 DEGREES C) | | | | |
| Defoamer, (BYK-1650) | 0.0000 | 0.0000 | 0.0000 | 0.0570 |
| (as supplied) | | | | |
| Deionized Water | 93.0000 | 92.5276 | 90.5150 | 89.58575 |
| % Solids | 7.0000 | 7.4724 | 9.4850 | 10.41425 |

TABLE 3
Results of Developer Trials

| | | | | | | | | Stain |
|---|---|---|---|---|---|---|---|---|
| | | | | | | | | Test |
| | | Dwell | Clearing | Weight | Color | Sludge | Filter | White |
| | Temp | Time | Point | Loss | Loss | Depth | Sludge | HDPP |
| Formula | ° C. | Sec. | mJ/cm² | % | Delta E | mm | grams | Delta E |
| 1 | 24 | 30 | 175 | 47.61 | 14.7 | 14 | | |
| 2 | 23 | 27 | 140 | 35.7 | 13.9 | 10 | | |
| 3 | 22 | 25 | 140 | 34.33 | 11.9 | 0 | | |
| 4 | 23 | 24 | 150 | 30.8 | 7.8 | — | 304 | 0.54 |
| Control | 24 | 30 | 138 | 37.2 | 12.4 | — | 427 | 42.22 |

### Example 1

A 9% sodium metasilicate solution was used to develop an irradiated lithographic precursor at 24° C. for 30 seconds. The clearing point of 175 mJ/cm² is higher than the preferred clearing point of 140 to 160 mJ/sq centimeters. The weight loss is high which indicates that the sodium metasilicate is removing more unimaged coating than normal. The presence of measurable sludge indicates that the developer does not have additives of this invention to keep the aluminosilicate, formed in the process of developing the plate, from forming sludge.

### Example 2

Formulating with the materials of this invention increases the aggressiveness of the developer. To compensate for a more aggressive developer, the processor temperature and dwell time are lowered. The benefit is that the amount of energy required to clear the plate is reduced to 140 mJ/cm². Also the color loss and weight loss are lowered, which results in more printed impressions before the image begins to deteriorate.

### Example 3

In Example 3 the sodium metasilicate is increased in order to give the developer more capacity to develop plates. The result is that in the sludge test no sludge is formed. When the capacity of the developer is exceeded the developer can form silicates which will over time settle out in the form of sludge. Increasing the sodium metasilicate also increases the aggressiveness of the developer. As before, the temperature and/or time can be reduced to achieve the same clearing point without increasing the weight loss and Delta E (color loss).

### Example 4

Formulating with additional materials of the invention increases the aggressiveness of the developer. To compensate for a more aggressive developer, the processor temperature and dwell time are lowered. The benefit is that the amount of energy required to clear the plate is reduced to 150 mJ/cm², the weight loss is reduced to 30.8% and the Delta E is reduced to 7.8 for color loss. Most importantly, the sludge build-up on the processor filter is reduced by 28.8% and the staining is reduced by 99.9% over the control developer.

When an irradiated lithographic precursor is developed, the “clearing point” is the minimum irradiating energy density required during imaging, to give an optical density difference of less than 0.01 between the imaged and developed area, on the one hand, and an area of the plate where an unimaged section of the imageable coating has been entirely removed with a suitable solvent, on the other. This number is obtained by illuminating different areas of a lithographic printing precursor with different energy densities and searching for the energy at which the difference in such optical density is below 0.01.

“Weight loss” is defined in this present specification as the weight of unimaged imageable coating that is removed by the developer, expressed as a percentage of the original weight of imageable coating before development.

“Delta E” is the difference in color between, on the one hand, an undeveloped and unimaged surface of the lithographic printing precursor, and an irradiated and developed surface of the precursor, on the other. It is determined from the formula:
Delta E=((L_{f}−Lᵢ)²+(a_{f}−aⱼ)²+(b_{f}−bⱼ)²)^{0.5} Formula I

where L, a and b are the three Lab-colour space values for the material measured, and where the subscripts i and j refer to the initial reading before development and after development, respectively.

The “sludge depth” was determined as follows: Developers to be tested were placed in a 24° C. (or other specified temperature) water bath for at least 1 hour before the sludge test. The temperature of the developer was measured before developing the first plate to confirm it is in the expected temperature range (±0.5° C.).

Of the above developer, 250 mL was measured using a graduated cylinder and poured into a plastic dish container sitting in the water bath. One PTP plate (15 cm×30 cm) was fully imaged and developed in the developer for 30 seconds whilst agitating the developer. At the end of the 30 seconds, the plate was taken out of the developer and run through a hand-roller squeezing device. The developer squeezed off the plate was directed back into the dish container. After 12 plates had been run through the developer in this manner, two plastic culture tubes were filled (about 13 grams each) with the spent developer. One was placed in a 40° C. oven for 48 hours while the other one was placed in a bench drawer at room temperature for the same period of time. After 48 hours the depth of sludge in the bottom of the culture tube was measured from the bottom of the culture tube to the top of the sludge layer using a millimeter graduated ruler.

Filter sludge was determined as follows: A 100 μm wound filter suitable for the developer processor is pre-wet with developer, allowed to drain of excess developer for approximately 10 minutes and weighed (initial filter weight). The filter is placed in the filter housing in the process to filter the developer during use and draining of the processor. A plate load test is then conducted. Fully imaged plates are passed through the developer in the processor without replenishment and without adding antioxidant until approximately 5.8 square meters per liter of developer (spent developer) have been developed. The spent developer is then drained out of the processor through the filter. The filter is allowed to drain of liquid developer for approximately 10 minutes and weighed (final filter weight). The filter sludge weight is the final filter weight minus the initial filter weight.

The stain test was determined as follows: Two drops of spent developer are placed on a suitable substrate for stain testing. After drying the stained area is rinse off the substrate using tap water. After the rinsed area has dried the Delta E is determined by measuring (L_{f}, a_{f}, b_{f}) after the dried developer has been rinsed off, and (L_{f}, aᵢ, bᵢ) of a blank substrate.

Delta E=((L_{f}−Lᵢ)²+(a_{f}−aⱼ)²+(b_{f}−bⱼ)²)^{0.5} where “i” denotes the initial (L, a, b) of a blank/clean substrate before applying the developer and “f” denotes the final color component of the substrate plus stain after rinsing off the developer. The smaller the Delta E value the less residual staining of the substrate.

There have thus been outlined the important features of the invention in order that it may be better understood, and in order that the present contribution to the art may be better appreciated. Those skilled in the art will appreciate that the conception on which this disclosure is based may readily be utilized as a basis for the design of other methods and apparatus for carrying out the several purposes of the invention. It is most important, therefore, that this disclosure be regarded as including such equivalent methods and apparatus as do not depart from the spirit and scope of the invention.

What is claimed is:

1. A developer for radiation-sensitive compositions comprising in an aqueous medium
(a) sodium metasilicate;
(b) at least one of a steric stabilizer and an electrosteric stabilizer; and
(c) at least one of a rinse aid and a phase stabilizer.

2. The developer of claim 1, further comprising at least one of
(a) a moderator,
(b) a wetting agent, and
(c) a dispersing agent.

3. The developer of claim 1, wherein the steric stabilizer is a natural gum or the electrosteric stabilizer is an aqueous soluble low molecular weight polymer.

4. The developer of claim 1, wherein the electrosteric stabilizer is at least one of an aqueous soluble polyacrylate, an aqueous soluble polysaccharide and an aqueoius soluble derivative of a polysaccharide.

5. The developer of claim 1, wherein the electrosteric stabilizer is a derivative of an aqueous soluble cellulosic polymer.

6. The developer of claim 1, wherein the rinse aid is a non-ionic surfactant.

7. The developer of claim 1, wherein the phase stabilizer is one of an alkyl sulfate, an alkyl sulfonate, an alkyl aryl sulfonate, an alkyl naphthalene sulfonate and an amphoteric surfactant.

8. The developer of claim 1, wherein the phase stabilizer is octyl dipropionate or one of beta-N-alkylaminopropionic acid, n-alkyl-beta-iminodipropionic acid, imidazoline carboxylate, n-alky-lletaine, an amine oxide, sulfobetaine and sultaine.

9. The developer of claim 2, wherein the moderator is a cationic surfactant.

10. The developer of claim 2, wherein the moderator is a high ratio sodium silicate.

11. The developer of claim 2, wherein the wetting agent is an anionic surfactant.

12. The developer of claim 2, wherein the dispersing agent is one of a naphthalene sulfonic acid sodium salt of a formaldehyde condensate and alkyl naphthalene sulfonic acid sodium salt of a formaldehyde condensate.

13. A method for making a lithographic master, the method comprising in the order stated the steps of:
(a) imagewise irradiating a positive-working lithographic printing precursor with radiation; and
(b) treating the imagewise irradiated precursor with a developer comprising in an aqueous medium
(i) sodium metasilicate,
(ii) at least one of a steric stabilizer and an electrosteric stabilizer, and
(iii) at least one of a rinse aid and a phase stabilizer,
wherein the precursor comprises on a substrate a coated and dried layer of a radiation-sensitive composition comprising an acetal resin derived from polyvinyl alcohol by condensation with aldehydes.

14. The method of claim 13, wherein the developer further comprises at least one of
(a) a moderator,
(b) a wetting agent, and
(c) a dispersing agent.

15. The method of claim 13 wherein the acetal resin has the structure 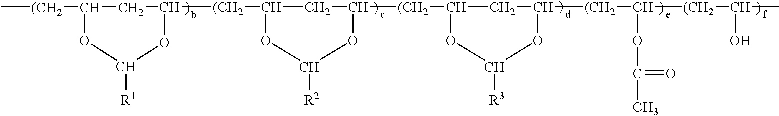
in which R¹ is —CₙH₂ₙ₊₁ where n=1 to 12,
and R²is 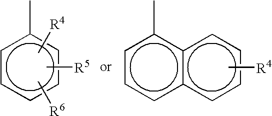
wherein R⁴=—OH;
R⁵=—OH or —OCH₃ or Br—or —O—CH₂—C≡CH and
B⁶=Br— or NO₂
R³=—(CH₂)ₜ—COOH, —C≡CH, or 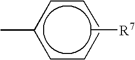
where R⁷=COOH, —(CH₂)ₜ—COOH, —O—(CH₂)ₜ—COOH
and in which t=1 to 4, where b=5 to 40 mole %,
c=10 to 60 mole %,
d=0 to 20 mole %,
e=2 to 20 mole %,
and f=5 to 50 mole %.

16. A method for eluating a deposit that results from treating a lithographic printing precursor with an alkaline developer composition, the deposit comprising a solid mix of sludge and image colorant, the method comprising, in the order given, the steps of:
(a) treating the deposit with an acid solution to yield liberated image colorant; and
(b) treating the liberated image colorant with a cleaning composition comprising
(i) at least one organic solvent, the at least one organic solvent being at least one of water-dispersible and water-soluble,
(ii) an image colorant dispersant, and
(iii) water.

17. The method of claim 16, wherein the image colorant dispersant is at least one of an alkylaryl sulfonate, a carboxylic acid alkali salt, a fatty acid alkali salt, an alkyl sulfonate, an olefin sulfonate, a phosphate ester, an alkyl sulfate, an alkylaryl sulfate, an aryl sulfonate and an alkyl phenol alkoxylate.

18. The method of claim 16, wherein the image colorant dispersant is a naphthalene sulfonate formaldehyde copolymer.

19. The method of claim 16, wherein the acid solution comprises at least one of nitric acid, sulfuric acid, phosphoric acid, hydrochloric acid.

20. The method of claim 16, wherein the developer comprises in an aqueous medium
(a) sodium metasilicate,
(b) at least one of a steric stabilizer and an electrosteric stabilizer and
(c) at least one of a rinse aid and a phase stabilizer.

21. The method of claim 20, wherein the image colorant dispersant and the dispersing agent is the same agent.

22. The method of claim 16, wherein the lithographic printing precursor comprises on a substrate a coated and dried layer of a radiation-sensitive composition comprising an acetal resin that has the structure 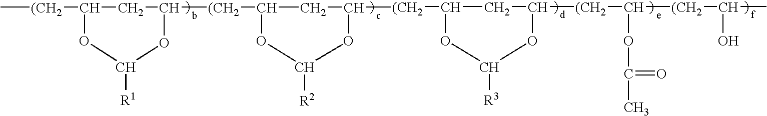
in which R¹ is —CₙH₂ₙ₊₁ where n=1 to 12,
and R² is 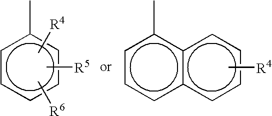
wherein R⁴=—OH;
R⁵=—OH or —OCH₃ or Br— or —O—CH₂—C≡CH and
B⁶=Br— or NO₂
R³=—(CH₂)ₜ—COOH, —C≡CH, or 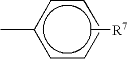
where R⁷=COOH, —(CH₂)ₜ—COOH, —O—(CH₂)ₜ—COOH
and in which t=1 to 4, where b=5 to 40 mole %,
c=10 to 60 mole %,
d=0 to 20 mole %,
e=2 to 20 mole %,
and f=5 to 50 mole %.

23. The method of claim 22, wherein the acid solution comprises an inorganic acid.

24. The method of claim 22, wherein the acid solution comprises nitric acid of concentration less than 15 wt %.

25. A lithographic master made by the method of claim 13.

26. A lithographic master made by the method of claim 15.
